(19) United States
(12) Patent Application Publication
(10) Pub. No.: US 2012/0099922 A1
(43) Pub. Date: Apr. 26, 2012

(54) SWINGABLE CONNECTING DEVICE

(75) Inventors: Masao Horikawa, Osaka (JP); Hiroki Kitano, Osaka (JP)

(73) Assignee: NANIWA IRON WORKS CO., LTD., Osaka-shi, Osaka (JP)

(21) Appl. No.: 13/320,301

(22) PCT Filed: Nov. 16, 2009
(86) PCT No.: PCT/JP2009/069441

§ 371 Date: Jan. 5, 2012

(30) Foreign Application Priority Data
May 15, 2009 (JP) 2009-118808

(51) Int. Cl. F16C 11/04

(52) U.S. Cl. 403/79

(57) ABSTRACT

A swingable connecting device includes an oscillation supporting mechanism for swingably supporting a shackle to a supporting body. A mounting bolt of the supporting body has a first male threaded portion and a second male threaded portion formed separately at opposite ends thereof with different diameters. A bolt shaft portion whose diameter varies continuously from the first male threaded portion to the second male threaded portion is formed between the first male threaded portion and the second male threaded portion. The supporting body is provided with a bolt hole for allowing the bolt shaft portion to fit into and engage with the bolt bore, through which the small-diameter second male threaded portion extends. The bolt bore has an inner surface profile, in which an inner diameter thereof continuously varies with an outer circumferential surface of the bolt shaft portion. A nut integrally connects the mounting bolt with the supporting body.

### TECHNICAL FIELD

The present invention relates to a swingable connecting device comprising a shackle; a supporting body capable of being screwed to a target object through a mounting bolt; and an oscillation supporting mechanism for swingably supporting the shackle to the supporting body, the oscillation supporting mechanism being formed by providing a retainer member for allowing connecting holes formed in a pair of leg portions of the shackle to fit on a pair of shaft portions integrally formed with the supporting body and having smooth outer circumferential surfaces, thereby to prevent the leg portions from removing from the shaft portions.

### BACKGROUND ART

As shown in FIG. 5, a conventional swingable connecting device includes a mounting bolt 11 having a large-diameter head portion for rotating operation at one end portion thereof and a male threaded portion 11B with a constant diameter at the other end portion thereof The mounting bolt 11 is configured to extend through a bolt bore formed in a supporting body 19 and is screwed to a target object, thereby to swingably attach the shackle 5 to the target object through the supporting body 19 (see Patent Document , for example).

### PRIOR ART DOCUMENT

### Patent Document

Patent Document 1: Japanese Unexamined Patent Application Publication. No. 2002-154781

### SUMMARY OF INVENTION

### Technical Problem

The conventional swingable connecting device noted above can be suspended by engaging the shackle 5 with a hook. The diameter of the mounting bolt 11 to be screwed to the target object is fixed depending on a dimension between a pair of leg portions 5a of the shackle 5. Thus, if a threaded bore formed in advance in the target object has a large diameter, it is required to attach a large-diameter mounting bolt 11 corresponding to such a large-diameter threaded bore. In this, it is necessary to use the supporting body 19 having the shackle 5 defining an increased dimension between the leg portions 5a to correspond to the diameter of the mounting bolt 11, which would make the connecting device heavy and decrease the handling efficiency and result in an expensive product.

The object of the present invention is to provide a swingable connecting device having a supporting body to be attached to a large-diameter threaded bore formed in a target object without changing the size of the shackle or the supporting body.

### Solution to Problem

A swingable connecting device of the present invention has a first characteristic feature as described below. The swingable connecting device of the present invention comprises a shackle, a supporting body capable of being screwed to a target object through a mounting bolt, and an oscillation supporting mechanism for swingably supporting the shackle to the supporting body. In the oscillation supporting mechanism, a pair of shaft portions integrally formed with the supporting body and having smooth outer circumferential surfaces are fitted to connecting holes formed in a pair of leg portions of the shackle. A retainer member is provided in the fitting portion for preventing the leg portions from removing from the shaft portions. The mounting bolt is a double-ended bolt having a large-diameter first male threaded portion and a small-diameter second male threaded portion formed separately at opposite ends thereof and having different diameters from each other. A bolt shaft portion whose diameter varies continuously from the first male threaded portion to the second male threaded portion is formed between the first male threaded portion and the second male threaded portion. The large-diameter first male threaded portion serves as a connecting portion relative to the target object. The supporting body is provided with a bolt hole for allowing the bolt shaft portion to fit into and engage with the bolt bore, through which the small-diameter second male threaded portion extends. The bolt bore has an inner surface profile, in which an inner diameter thereof continuously varies with an outer circumferential surface of the bolt shaft portion. The bolt shaft portion is fitted to the bolt bore, and a nut is screwed to the second male threaded portion extending through the bolt bore. As a result, the mounting bolt is integrally connected to the supporting body to prevent the mounting bolt from removing from the supporting body.

According to the first characteristic feature of the present invention, the mounting bolt is formed as the double-ended bolt in which the small-diameter second male threaded portion has the same diameter as that of the conventional mounting bolt to extend through the bolt bore of the supporting body and to be screwed by the nut. This allows the mounting bolt to be attached to the supporting body without changing the size of the supporting body or the shackle. As a result, it is prevented or suppressed that the entire device becomes heavy, and the handling efficiency is satisfactorily maintained.

On the other hand, the first male threaded portion has a diameter different from that of the second male threaded portion to provide the connecting portion to be screwed to the large-diameter bolt bore of the target object.

For example, if the connecting device is pulled from a direction perpendicular to the axis of the mounting bolt in an attempt to lift the target object by engaging the hook with the shackle swingably supported to the supporting body, a bending force exerted on the mounting bolt is concentrated at a stepped portion formed between the first male threaded portion and the second male threaded portion having different diameters from each other, which would. easily break the mounting bolt. According to the present invention, the bolt shaft portion is formed to vary its diameter continuously from the first male threaded portion to the second male threaded portion, while the bolt bore has an inner surface profile, in which an inner diameter thereof continuously varies with an outer circumferential surface of the bolt shaft portion. Therefore, the bolt shaft portion has no cut-away stepped portion at which stress, in particular, is easily concentrated, and thus even if bending stress is exerted on the bolt when the target object is lifted, such stress is not concentrated at one part but distributed to be transmitted to the supporting body.

As a result, the swingable connecting device having an increased bending bearing force can be provided.

A second characteristic feature of the present invention lies in that a rotation supporting mechanism is provided between the mounting bolt and the supporting body for supporting the shackle to the mounting bolt to be relatively rotatable about an axis of the mounting bolt.

According to the second characteristic of the present invention, in addition to the functions and effects achieved by the first characteristic feature noted above, the position or posture of the shackle is variable depending on the pulling direction, which would advantageously be user-friendly.

### BRIEF DESCRIPTION OF DRAWINGS

FIG. 1 is a partially cut-away front view of a swingable connecting device of the present invention;

FIG. 2 is a side view of the swingable connecting device of the present invention;

FIG. 3 is an exploded perspective view of the swingable connecting device of the present invention;

FIG. 4 is a partially cut-away front view of the swingable connecting device of the present invention according to a modified embodiment; and

FIG. 5 is a partially cut-away front view of a conventional swingable connecting device.

### MODE FOR CARRYING OUT INVENTION

An embodiment of the present invention will be described hereinafter in reference to the accompanying drawings.

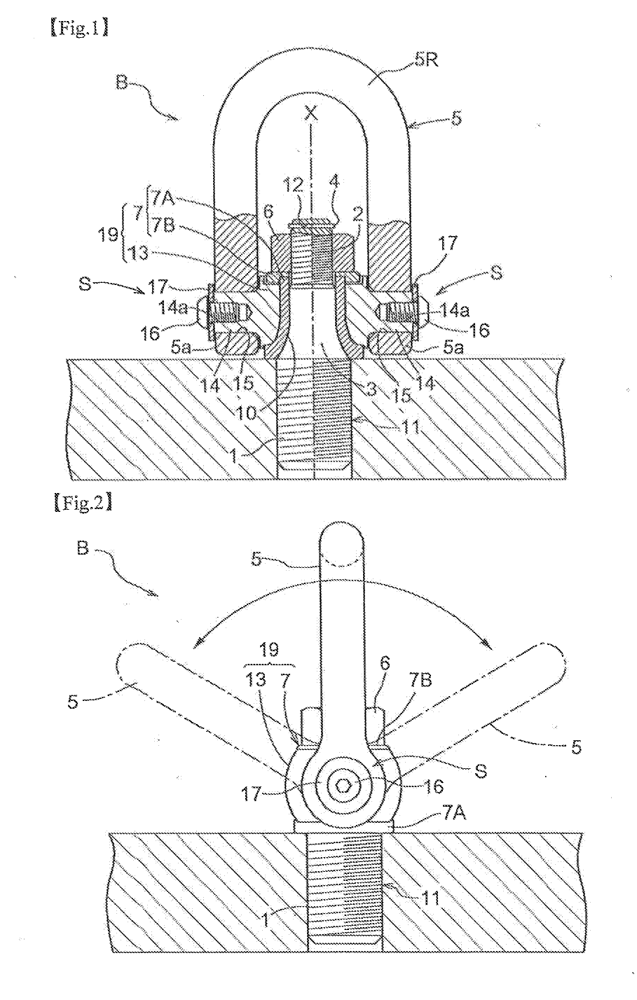

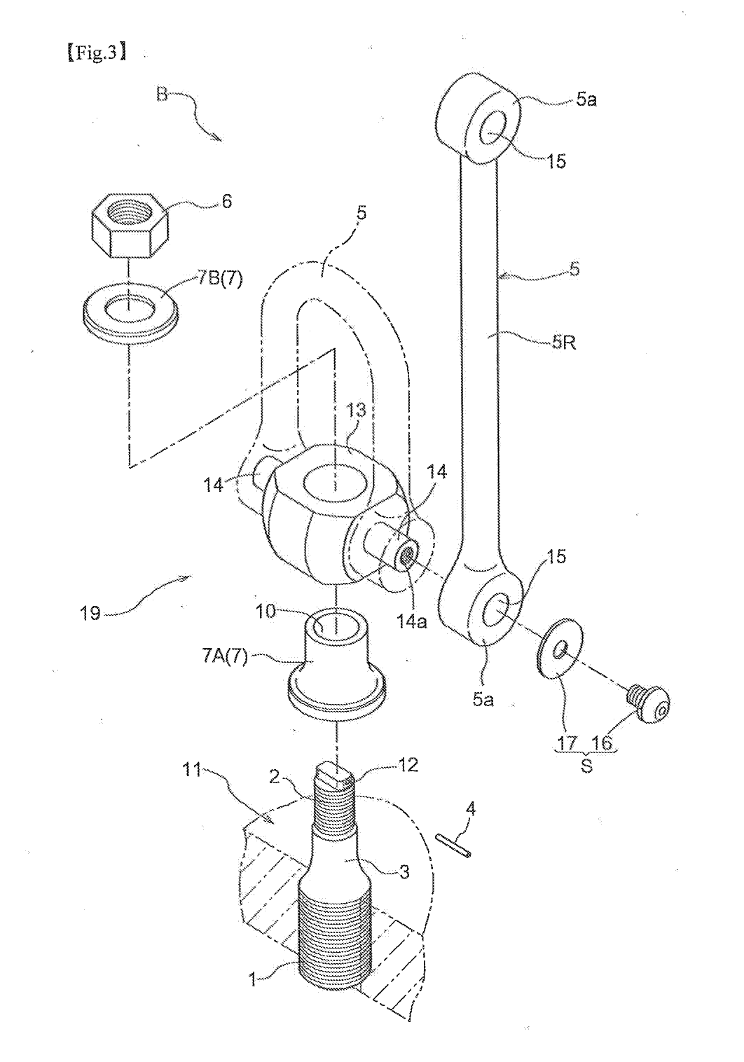

FIGS. 1 and 2 show a swingable connecting device B in an assembled state, respectively. FIG. 3 is an exploded perspective view of the device.

The swingable connecting device includes a shackle 5, a supporting body 19 screw-engageable with a target object through a mounting bolt 11, and an oscillation supporting mechanism for swingably supporting the shackle 5 to the supporting body 19. The oscillation supporting mechanism is formed by providing a retainer member S for allowing connecting holes formed in a pair of leg portions 5a of the shackle 5 to fit on a pair of shaft portions 14 integrally formed with the supporting body 19 and having smooth outer circumferential surfaces, thereby to prevent the leg portions 5a from removing from the shaft portions 14.

The mounting bolt 11 is a double-ended bolt having a large-diameter first male threaded portion 1 and a small-diameter second male threaded portion 2 formed separately at opposite ends thereof and having different diameters from each other. A bolt shaft portion 3 whose diameter varies continuously from the first male threaded portion 1 to the second male threaded portion 2 is formed between the first male threaded portion 1 and the second male threaded portion 2. The large-diameter first male threaded portion 1 serves as a connecting portion relative to the target object, The supporting body 19 is provided with a bolt hole 10 for allowing the bolt shaft portion 3 to fit into and engage with the bolt bore 10, The small-diameter second male threaded portion 2 extends through the bolt bore 10, and has an inner surface profile, in which an inner diameter thereof continuously varies with an outer circumferential surface of the bolt shaft portion 3. A nut 6 is screwed to the second male threaded portion 2 extending through the bolt bore 10 with the bolt shaft portion 3 being fitted to the bolt bore 10, thereby to retain the mounting bolt 11 to be integrally connected to the supporting body 19.

The inversed U-shaped shackle 5 is formed by bending a linear shackle double-ended rod 5R shown in FIG. 3 at hot temperature (or at room temperature), In bending the rod, connecting bores 15 are fitted to the shaft portions 14 as well. More particularly, the shackle 5 is fixedly fitted on the shaft portions 14 and normally is not removed. However, when a considerable tensile load is applied to the shackle 5, the shackle 5 might be opened and deformed. Thus, a washer 17 is held in a threaded bore 14a formed in each of the shaft portions 14 through a screw 16 to form the retainer member S for preventing the leg portion 5a from removing from the shaft portion 14.

The threaded bore 14a with its pilot bore has an innermost portion that does not reach a root of the shaft portion 14. Thus, it is avoided that a cross section of the proximal root portion of the shaft portion 14, which receives a shearing force produced by the load from the shackle 5, is diminished. This also contributes to increase the shearing force.

The supporting body 19 has a boss member 7 having the bolt bore 10 formed in an inner side thereof, and a trunnion 13 fitted onto the boss portion 7. The trunnion 13 is fitted on the boss member 7 to be rotatable about a vertical axis X extending along the bolt axis, thereby to form a rotation supporting mechanism for supporting the shackle 5 to the mounting bolt 11 to be relatively rotatable about the axis.

The boss member 7 is fowled by press-fitting connection between a bell-shaped lower boss 7A with the bolt bore 10 having a diameter increasing toward the lower side thereof, and a lid-shaped upper boss 7B provided with the bolt bore 10. The second male threaded portion 2 and the bolt shaft portion 3 of the mounting bolt 11 extend through both the bolt bores 10, while the nut 6 is screwed to the second male threaded portion 2, thereby to retain the mounting bolt 11 from removing from the supporting body 19.

In order to prevent the nut 6 from loosening and removing from the second male threaded portion 2, a retainer pin 4 is removably inserted into a pin hole 12 formed in the second male threaded portion 2 along a radial direction of the threaded portion.

### Modified Embodiment

A modified embodiment will be described hereinafter.

The diameter of the first male threaded portion 1 and the bolt bore 10 corresponding the diameter of the first male threaded portion 1 are variable in combination with the second male threaded portion 2, and may be formed to adapt to an existing bolt bore 10 formed in the target object.

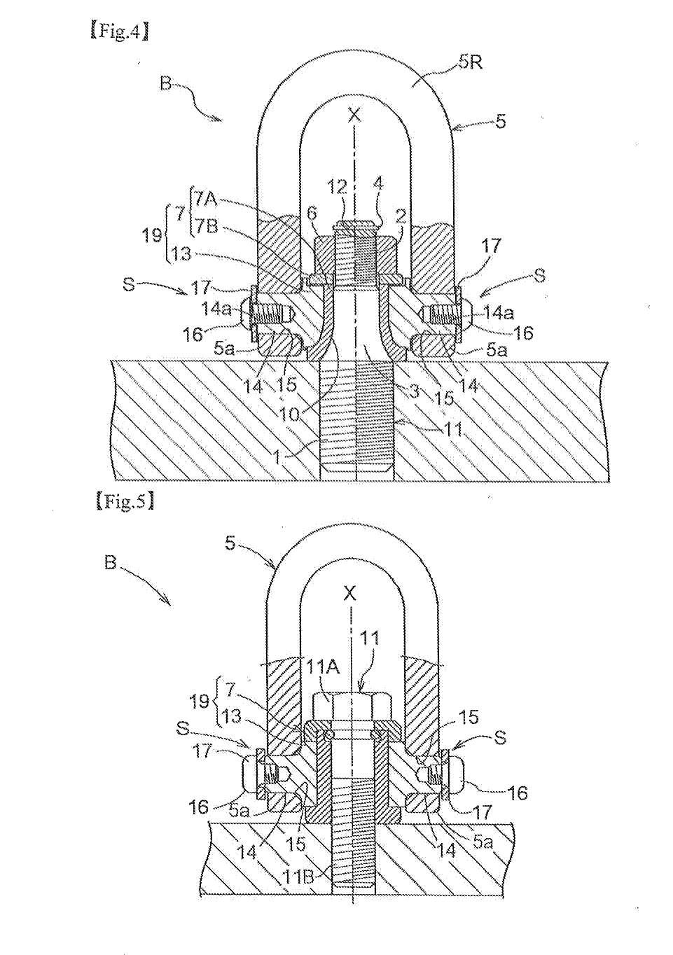

Instead of press-fitting, the lower boss 7A and the upper boss 7B may be simply brought into contact with each other as shown in FIG. 4, thereby to form the boss member 7. This allows the boss member 7 to be disassembled easily and replaced with another boss member 7 corresponding to another mounting bolt 11 having a different combination of the diameters of the first male threaded portion 1 and the second male threaded portion 2.

The retainer pin 4 relative to the nut 6 may also have a retaining function for the nut 6 by being inserted into a pin hole penetrating through both the nut 6 and the second male threaded portion 2.

The boss member 7 is provided for easily supporting the supporting body 19 to be rotatable about the bolt axis. Instead, the boss member 7 is dispensable and a bolt bore may be provided in the trunnion 13 for directly receiving the mounting bolt 11.

Although the reference numbers are assigned as noted above for easy comparison with the drawings, it is not intended to limit the present invention to the structures shown in the drawings. Naturally, various modifications are possible without departing from the scope of the claims of the present invention.

### INDUSTRIAL USABILITY

The swingable connecting member of the present invention is configured to be mounted on a target object to be raised by a crane, for example, to change a mounting position of the target object or transport the target object.

1. A swingable connecting device comprising;
a shackle;
a supporting body capable of being screwed to a target object through a mounting bolt; and
an oscillation supporting mechanism for swingably supporting the shackle to the supporting body, the oscillation supporting mechanism being formed by providing a retainer member for allowing connecting holes formed in a pair of leg portions of the shackle to fit on a pair of shaft portions integrally formed with the supporting body and having smooth outer circumferential surfaces, thereby to prevent the leg portions from removing from the shaft portions;
wherein the mounting bolt is a double-ended bolt having a large-diameter first male threaded portion and a small-diameter second male threaded portion formed separately at opposite ends thereof and having different diameters from each other,
wherein a bolt shaft portion whose diameter varies continuously from the first male threaded portion to the second male threaded portion is formed between the first male threaded portion and the second male threaded portion,
wherein the large-diameter first male threaded portion serves as a connecting portion. relative to the target object,
wherein the supporting body is provided with a bolt hole for allowing the bolt shaft portion to fit into and engage with the bolt bore, through which the small-diameter second male threaded portion extends,
wherein the bolt bore has an inner surface profile, in which an inner diameter thereof continuously varies with an outer circumferential surface of the bolt shaft portion, and
wherein a nut is screwed to the second male threaded portion extending through the bolt bore with the bolt shaft portion being fitted to the bolt bore, thereby to retain the mounting bolt to be integrally connected to the supporting body.

2. The swingable connecting device as claimed in claim 1, wherein a rotation supporting mechanism is provided between the mounting bolt and the supporting body for supporting the shackle to the mounting bolt to be relatively rotatable about an axis of the mounting bolt.
